(19) United States
(12) Patent Application Publication
(10) Pub. No.: US 2025/0304085 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Haruhiko Nishiguchi, Tokyo (JP); Hiroshi Oguro, Tokyo (JP); Naito Suzuki, Tokyo (JP)

(21) Appl. No.: 19/058,043

(22) Filed: Feb. 20, 2025

(30) Foreign Application Priority Data
Mar. 28, 2024 (JP) 2024-053714

(51) Int. Cl. B60W 50/08; B60W 30/14

(52) U.S. Cl. CPC B60W 50/085; B60W 30/143; B60W 2540/00; B60W 2552/30; B60W 2720/10

(57) ABSTRACT

A control device determines whether or not a driver of a vehicle is gripping a steering wheel while the vehicle is traveling on a curved road, causes an output device to output first information in an object segment between the first curved road and a second curved road that is the next curved road after the first curved road on which the vehicle is scheduled to travel in a gripping state in which the driver is gripping the steering wheel, and causes the output device to output second information different from the first information in the object segment in a non-gripping state in which the driver is not gripping the steering wheel.

### CROSS-REFERENCE TO RELATED APPLICATION

Priority is claimed on Japanese Patent Application No. 2024-053714, filed Mar. 28, 2024, the content of which is incorporated herein by reference.

### BACKGROUND

### Field of the Invention

The present invention relates to a control device, a control method, and a storage medium.

### Description of Related Art

In recent years, efforts to provide sustainable transportation systems that take into account various situations have become active. For this realization, research and development aims to further improve traffic safety and convenience through research and development of driving assistance technology. Conventionally, a travel control device of a vehicle that controls a target vehicle speed in accordance with a gripping state of a steering wheel at the time of traveling on a curve has been disclosed (Japanese Unexamined Patent Application, First Publication No. 2017-144776). This travel control device is configured to ensure that the above-described control does not cause any discomfort to an occupant of the vehicle.

### SUMMARY

However, it may be difficult for the above-described travel control device to provide useful information for an occupant of a vehicle. The above-described travel control device does not adequately account for the occupant and fails to significantly contribute to the development of a sustainable transportation system.

The present invention has been made in consideration of such circumstances, and an objective of the present invention is to provide a control device, a control method, and a storage medium for enabling useful information to be provided for an occupant of a vehicle. By extension, it can contribute to the development of a sustainable transportation system by accounting for the occupant.

A control device, a control method, and a storage medium according to the present invention adopt the following configurations.
(1): According to an aspect of the present invention, there is provided a control device including: a storage medium storing computer-readable instructions; and one or more processors connected to the storage medium, the processor executing the computer-readable instructions to: determine whether or not a driver of a vehicle is gripping a steering wheel while the vehicle is traveling on a first curved road, cause an output device to output first information in an object segment between the first curved road and a second curved road that is the next curved road after the first curved road on which the vehicle is scheduled to travel in a gripping state in which the driver is gripping the steering wheel, and cause the output device to output second information different from the first information in the object segment in a non-gripping state in which the driver is not gripping the steering wheel.
(2): In the above-described aspect (1), the processor executes the computer-readable instructions to: acquire a distance of the object segment, and differentiate information to be output by the output device while the vehicle is traveling in the object segment on the basis of the distance of the object segment.
(3): In the above-described aspect (2), the processor executes the computer-readable instructions to: cause the output device to output the same information in the object segment even if the state is the gripping state or the non-gripping state when the object segment corresponds to a distance less than or equal to a first distance or when the object segment corresponds to a distance less than or equal to a third distance longer than a second distance longer than the first distance, and cause the output device to output third information in the gripping state when the object segment corresponds to a distance less than or equal to the second distance and cause the output device to output fourth information different from the third information in the non-gripping state.
(4): In the above-described aspect (3), the processor executes the computer-readable instructions to cause the output device to output information output by the output device during traveling on the first curved road or information having the same type as the output information in the object segment in the gripping state when the object segment corresponds to a distance less than or equal to the second distance.
(5): In the above-described aspect (3), the third information is information different from information for proposing that the driver should grasp the steering wheel.
(6): In the above-described aspect (3), the processor executes the computer-readable instructions to cause the output device to output information of a type different from that of the information output by the output device during traveling on the first curved road in the object segment in the non-gripping state when the object segment corresponds to a distance less than or equal to the second distance.
(7): In the above-described aspect (3), the fourth information is information for proposing that the driver should grasp the steering wheel.
(8): In any one of the above-described aspects (1) to (7), the processor executes the computer-readable instructions to: cause the vehicle to travel in a first speed plan when the driver is gripping the steering wheel on the first curved road, and cause the vehicle to travel in a second speed plan for causing the vehicle to travel at a lower speed than the first speed plan when the driver is not gripping the steering wheel on the first curved road.
(9): In any one of the above-described aspects (1) to (7), the processor executes the computer-readable instructions to: cause the vehicle to travel in a first speed plan when the driver is gripping the steering wheel on the first curved road, cause the vehicle to travel in a second speed plan at a lower speed than the first speed plan when the driver is not gripping the steering wheel on the first curved road, prevent any proposal that the vehicle should travel in a third speed plan for causing the vehicle to travel on the second curved road at a higher speed than a fourth speed plan if the steering wheel is gripped when the driver has not gripped the steering wheel on the first curved road in a case where the object segment is a first range of a preset distance, and propose that the vehicle should travel on the second curved road in a third speed plan if the steering wheel is gripped when the driver has not gripped the steering wheel on the first curved road in a case where the object segment is a preset distance range as a second range larger than the first range.
(10): In any one of the above-described aspect (9), the processor executes the computer-readable instructions to: cause the vehicle to travel on the second curved road in the third speed plan when the driver has gripped the steering wheel in accordance with the proposal, and cause the vehicle to travel on the second curved road in the fourth speed plan when the driver has not gripped the steering wheel without accepting the proposal.
(11): According to another aspect of the present invention, there is provided a control device including: a storage medium storing computer-readable instructions; and one or more processors connected to the storage medium, the processor executing the computer-readable instructions to: acquire a distance of an object segment between a first curved road and a second curved road that is the next curved road after the first curved road, prevent any proposal that a vehicle should travel on the second curved road in a third speed plan at a higher speed than a fourth speed plan if the steering wheel is gripped in a non-gripping state in which the driver of the vehicle is not gripping the steering wheel while the vehicle is traveling on the first curved road when the distance of the object segment between the first curved road and the second curved road is less than a predetermined distance, and propose that the vehicle should travel on the second curved road in the third speed plan at a higher speed than the fourth speed plan if the steering wheel is gripped in the non-gripping state in which the driver is not gripping the steering wheel while the vehicle is traveling on the first curved road when the distance of the object segment is greater than or equal to the predetermined distance.
(12): According to yet another aspect of the present invention, there is provided a control method including steps of: determining, by a computer, whether a driver of a vehicle is gripping a steering wheel while the vehicle is traveling on a first curved road; causing, by the computer, an output device to output first information in an object segment between the first curved road and a second curved road that is the next curved road after the first curved road on which the vehicle is scheduled to travel in a gripping state in which the driver is gripping the steering wheel, and causing, by the computer, the output device to output second information different from the first information in the object segment in a non-gripping state in which the driver is not gripping the steering wheel.
(13): According to yet another aspect of the present invention, there is provided a storage medium storing a program for causing a computer to execute steps of: determining whether a driver of a vehicle is gripping a steering wheel while the vehicle is traveling on a first curved road; causing an output device to output first information in an object segment between the first curved road and a second curved road that is the next curved road after the first curved road on which the vehicle is scheduled to travel in a gripping state in which the driver is gripping the steering wheel, and causing the output device to output second information different from the first information in the object segment in a non-gripping state in which the driver is not gripping the steering wheel.

According to aspects (1) to (13), the control device, control method, or storage medium can provide useful information for an occupant of the vehicle (e.g., the driver).

For example, the control device provides the driver with information based on the driver's determination result on the first curved road. Thereby, assistance is provided so that the vehicle more suitably travels for the driver on the second curved road.

According to aspects (2) to (7), the control device can provide the driver with appropriate information corresponding to a distance of the object segment.

### BRIEF DESCRIPTION OF THE DRAWINGS

FIG. 1 is a configuration diagram of a vehicle system using a vehicle control system according to an embodiment.

FIG. 2 is an explanatory diagram of speed adjustment control.

FIG. 3 is an explanatory diagram of a state of a driver and information provided via an HMI.

FIG. 4 is an explanatory diagram (Part 1) of the speed adjustment control.

FIG. 5 is an explanatory diagram (Part 2) of the speed adjustment control.

FIG. 6 is a flowchart (Part 1) showing an example of a flow of a process executed by a driving assistance device.

FIG. 7 is a flowchart (Part 2) showing the example of the flow of the process executed by the driving assistance device.

FIG. 8 is an explanatory diagram of a process in scene 1A.

FIG. 9 is an explanatory diagram of the process in scene 1B.

FIG. 10 is an explanatory diagram of a process in scene 2A.

FIG. 11 is an explanatory diagram of a process in scene 2B.

FIG. 12 is an explanatory diagram of a process in scene 3A.

FIG. 13 is an explanatory diagram of a process in scene 3B.

FIG. 14 is a flowchart showing an example of a flow of a process executed by the driving assistance device.

FIG. 15 is an explanatory diagram of each scene.

### DETAILED DESCRIPTION OF THE INVENTION

### Embodiments

### Overall Configuration

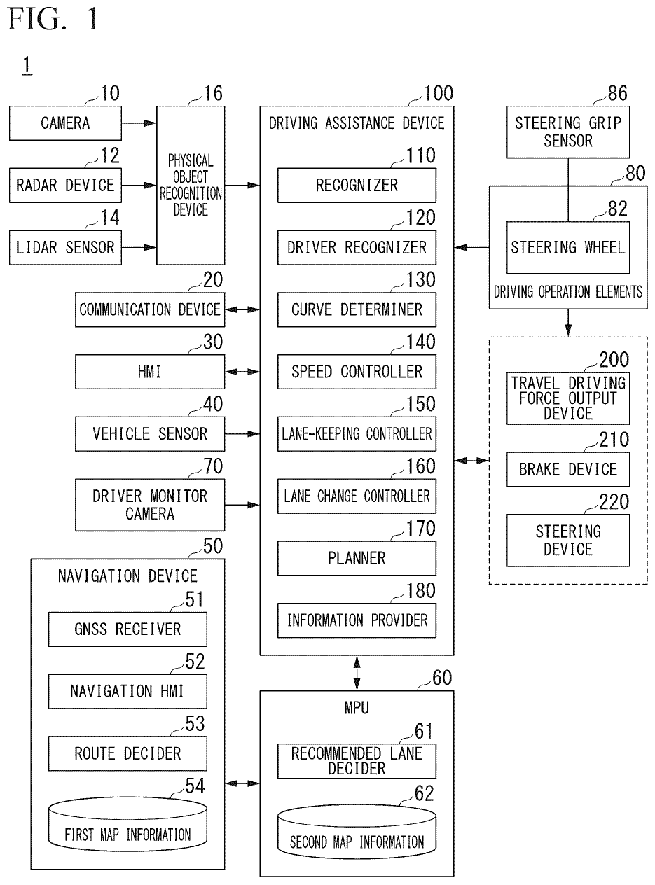

FIG. 1 is a configuration diagram of a vehicle system 1 including a vehicle control system according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, driving operation elements 80, an driving assistance device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added. The driving assistance device 100 is an example of a “vehicle control device.”

For example, the camera 10 is a digital camera using a solid-state imaging element such as, for example, a charge-coupled device (CCD) or a complementary metal oxide semiconductor (CMOS). The camera 10 is attached to any location on the vehicle (hereinafter referred to as a host vehicle M) in which the vehicle system 1 is mounted.

When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position of a physical object (a distance to and a direction of the physical object) by detecting radio waves (reflected waves) reflected by the physical object. The radar device 12 is attached to any position on the host vehicle M. The radar device 12 may detect a position and a speed of the physical object in a frequency modulated continuous wave (FM-CW) scheme.

The LIDAR sensor 14 radiates light to the vicinity of the host vehicle M (or electromagnetic waves having a wavelength close to that of light) and measures scattered light. The LIDAR sensor 14 detects a distance from an object on the basis of time from light emission to light reception. The radiated light is, for example, pulsed laser light. The LIDAR sensor 14 is attached to any location on the host vehicle M.

The physical object recognition device 16 performs a sensor fusion process on detection results from some or all of the camera 10, the radar device 12, and the LIDAR sensor 14 to recognize a position, a type, a speed, and the like of a physical object. The physical object recognition device 16 outputs recognition results to the driving assistance device 100. The physical object recognition device 16 may output detection results of the camera 10, the radar device 12, and the LIDAR sensor 14 to the driving assistance device 100 as they are. The physical object recognition device 16 may be omitted from the vehicle system 1.

The communication device 20 uses, for example, a cellular network, a Wi-Fi network, a Bluetooth (registered trademark) network, a dedicated short range communication (DSRC) network to communicate with other vehicles near the host vehicle M or communicate with various types of server devices via a radio base station.

The HMI 30 presents various types of information to an occupant of the host vehicle M and receives an input operation by the occupant. The HMI 30 includes various types of display devices, a speaker, a buzzer, a touch panel, a switch, keys, and the like. The HMI 30 includes a display device. The display device (display) is, for example, a display device, i.e., a multi-information display provided in the center of the instrument panel of the host vehicle M and configured to display various information in the host vehicle M such as a speedometer indicating a traveling speed of the host vehicle M or a tachometer indicating a rotational speed of the internal combustion engine provided in the host vehicle M.

The vehicle sensor 40 includes a vehicle speed sensor configured to detect the speed of the host vehicle M, an acceleration sensor configured to detect acceleration, a yaw rate sensor configured to detect angular velocity around a vertical axis, a direction sensor configured to detect a direction of the host vehicle M, and the like.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane decider 61 and holds second map information 62 in a storage device such as an HDD or a flash memory. The recommended lane decider 61 divides the route on the map provided from the navigation device 50 into a plurality of blocks (e.g., divides the route every 100 [m] in a traveling direction of the vehicle), and decides a recommended lane for each block with reference to the second map information 62. The recommended lane decider 61 decides in what lane numbered from the left the vehicle will travel. The recommended lane decider 61 decides the recommended lane so that the host vehicle M can travel along a reasonable route for traveling to a branching destination when there is a branch point in the route on the map.

The second map information 62 is map information that is more accurate than the first map information 54. The second map information 62 includes, for example, information about the center of the lane, information about the boundary of the lane, and the like. The second map information 62 may include road information, traffic adjustment information, address information (address/postal code), facility information, telephone number information, and the like. The second map information 62 may be updated at any time by the communication device 20 communicating with the external device.

The driver monitor camera 70 is, for example, a digital camera that uses a solid-state imaging element such as a CCD or a CMOS. The driver monitor camera 70 is attached to any location on the host vehicle M with respect to a position and a direction where the head of the occupant (hereinafter, the driver) sitting in the driver's seat of the host vehicle M can be imaged from the front (in a direction in which his or her face is imaged). For example, the driver monitor camera 70 is attached to an upper part of a display device provided on the central portion of the instrument panel of the host vehicle M. The driver monitor camera 70 outputs an image obtained by capturing the cabin including the driver of the host vehicle M from an arrangement position to the driving assistance device 100.

The driving operation elements 80 include, for example, an operation switch of a direction indicator, an accelerator pedal, a brake pedal, a shift lever, and other operation elements in addition to the steering wheel 82. A sensor for detecting an amount of operation or the presence or absence of an operation is attached to the driving operation element 80 and a detection result thereof is output to the driving assistance device 100 or some or all of the travel driving force output device 200, the brake device 210, and the steering device 220. The steering wheel 82 does not necessarily have to be annular and may be in the form of a variant steering wheel, a joystick, a button, or the like. A steering grip sensor 86 is attached to the steering wheel 82.

The steering grip sensor 86 is implemented, for example, by a capacitance sensor, a piezoelectric element, or the like. The steering grip sensor 86 detects whether or not the driver is gripping the steering wheel 82. Gripping includes a state in which the driver is gripping the steering wheel 82, a state in which the hand is in contact with the steering wheel 82, a state in which a force of a predetermined degree or higher is applied to the steering wheel 82, or the like.

The steering grip sensor 86 may detect gripping on the basis of an image captured by a camera or detect gripping using an optical method such as a radar device (a method that does not require contact with the sensor).

The driving assistance device 100 includes, for example, a recognizer 110, a driver recognizer 120, a curve determiner 130, a speed controller 140, a lane-keeping controller 150, a lane change controller 160, a planner 170, and an information provider 180. Some or all of these functional elements are implemented, for example, by a hardware processor such as a central processing unit (CPU) executing a program (software). Also, some or all of the above components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the driving assistance device 100 or may be stored in a removable storage medium such as a DVD or a CD-ROM and installed in an HDD or a flash memory of the driving assistance device 100 when the storage medium (the non-transitory storage medium) is mounted in a drive device.

On the basis of information input from the camera 10, the radar device 12, and the LIDAR sensor 14 via the physical object recognition device 16, the recognizer 110 recognizes a state of a position, velocity, acceleration, and the like of a physical object in the vicinity of the host vehicle M. The position of the physical object, for example, is recognized as a position of an absolute coordinate system having a representative point of the host vehicle M (a center of gravity, a drive shaft center, or the like) as the origin, and is used for control. The position of the physical object may be represented by a representative point such as the center of gravity or a corner of the physical object or may be represented in a region. The “state” of the physical object may include the acceleration or jerk of the physical object, or the “action state” (e.g., whether or not the lane is changing or is about to change).

Also, for example, the recognizer 110 recognizes a lane in which the host vehicle M is traveling (a travel lane). For example, the recognizer 110 recognizes the travel lane by comparing a pattern of road markings (e.g., an arrangement of solid lines and broken lines) obtained from the second map information 62 with a pattern of road markings in the vicinity of the host vehicle M recognized from an image captured by the camera 10. The recognizer 110 may recognize a travel lane by recognizing a runway boundary (road boundary) including a road marking, a shoulder, a curb, a median strip, a guardrail, and the like as well as a road marking. In this recognition, a position of the host vehicle M acquired from the navigation device 50 or a processing result of the INS may be taken into account. The recognizer 110 recognizes a temporary stop line, an obstacle, red traffic light, a toll gate, and other road events.

When the travel lane is recognized, the recognizer 110 recognizes a position or an orientation of the host vehicle M with respect to the travel lane. For example, the recognizer 110 may recognize a deviation of a reference point of the host vehicle M from the center of the lane and an angle formed between the travel direction of the host vehicle M and a line connected to the center of the lane as a relative position and orientation of the host vehicle M related to the travel lane. Alternatively, the recognizer 110 may recognize a position of the reference point of the host vehicle M related to one side end portion (a road marking or a road boundary) of the travel lane or the like as a relative position of the host vehicle M related to the travel lane.

The driver recognizer 120 detects whether or not the driver is in a predetermined state on the basis of the image captured by the driver monitor camera 70. The predetermined state is a state in which hands-off lane-keeping control to be described below is executable. Hands-off is a state in which the driver is not gripping the steering wheel 82 and hands-on is a state in which the driver is gripping the steering wheel 82. The state in which hands-off lane-keeping control can be executed is a state in which the driver is monitoring the front (or the vicinity of the host vehicle M). Forward monitoring indicates, for example, that the driver monitors the front so that the driver can quickly make a change from a state in which the vehicle system 1 controls the host vehicle M to a state in which the driver operates the host vehicle M. Forward monitoring indicates, for example, that the driver's visual line is facing forward.

The curve determiner 130 identifies the position of the host vehicle M in the map information on the basis of the map information (the first map information 54 or the second map information 62) including information related to the lane and the position of the host vehicle M. The map information includes information indicating features of the road and the travel lane. The information indicating the features includes, for example, a radius of the circle of the curve (a curve radius). The information indicating the features may include information indicating that a curved road is a curved road where “speed adjustment control” to be described below is executable. The curved road may include a road that is curved and a road in a region within a predetermined distance of the road. For example, the region within the predetermined distance is a region corresponding to a position where the host vehicle M decelerates when entering a curve.

For example, the speed controller 140 automatically controls the travel driving force output device 200 and the brake device 210 without depending on the driver's operation and automatically controls the speed of the host vehicle M. The speed controller 140 executes so-called adaptive cruise control (ACC).

For example, when there is no other vehicle within a predetermined distance from the host vehicle M in front of the host vehicle M, the speed controller 140 automatically controls the travel driving force output device 200 and the brake device 210 without depending on the driver's operation so that the host vehicle M moves at a speed set by the driver, a legal speed, and a speed preset in accordance with a road.

For example, when there is another vehicle in front of the host vehicle M and within a predetermined distance from the host vehicle M, the speed controller 140 automatically controls the travel driving force output device 200 and the brake device 210 without depending on the driver's operation to track the other vehicle. Tracking indicates that the host vehicle M is behind the other vehicle and travels while maintaining a position of a predetermined distance from the other vehicle. The speed controller 140 performs speed adjustment control to be described below.

The lane-keeping controller 150 controls the steering device 220 so that the host vehicle M does not deviate from the travel lane. For example, the lane-keeping controller 150 controls the steering device 220 so that the host vehicle M travels in the center of the travel lane recognized by the recognizer 110 or near the center. Hereinafter, this control may be referred to as “lane-keeping control.” The lane-keeping controller 150 executes hands-on lane-keeping control and hands-off lane-keeping control.

The hands-on lane-keeping control is control that is executed in a state in which the driver is gripping the steering wheel 82 (a state in which the steering grip sensor 86 has detected the gripping of the steering wheel 82). A condition under which hands-on lane-keeping control is executable is less stringent than that under which hands-off lane-keeping control is executable. For example, hands-on lane-keeping control is executed on the condition that the speed of the host vehicle M is greater than or equal to a predetermined speed and the driver is monitoring the front.

The hands-off lane-keeping control is control executable in a state in which the driver is not gripping the steering wheel 82 (a state in which the steering grip sensor 86 has not detected the gripping of the steering wheel 82). The hands-off lane-keeping control is executable, for example, when the following conditions are satisfied. The speed of the host vehicle M is greater than or equal to a predetermined speed, the host vehicle M is traveling on a predetermined road (e.g., a preset road or road type in which hands-off lane-keeping control is executable), and the driver is monitoring the front. The hands-off lane-keeping control is executed when the driver is monitoring the front and the hands-off lane-keeping control is not executed or stops when the driver is not monitoring the front.

The conditions under which the above-described hands-on lane-keeping control and hands-off lane-keeping control is executable are examples, other conditions (e.g., a condition that the host vehicle M is tracking a preceding vehicle) may be included or some conditions may be omitted. It is only necessary for the conditions under which hands-on lane-keeping control is executable to be less stringent than the conditions under which hands-off lane-keeping control is executable (or it is only necessary for the conditions under which hands-off lane-keeping control is executable to be more stringent than the conditions under which hands-on lane-keeping is executable).

The lane change controller 160 causes the host vehicle M to change lanes automatically. The lane change controller 160 causes the host vehicle M to change lanes on the basis of the destination and route set by the occupant and the recommended lane output to the MPU 60. For example, the lane change controller 160 can make a lane change when a lane change is required to go to the destination. The lane change controller 160 causes the host vehicle M to change lanes automatically (an automatic lane change (ALC)) when a lane change instruction has been issued by the driver in a state in which the hands-off lane-keeping control is executed. The lane change instruction is an operation of a lever part of the operation switch of the direction indicator. For example, if the lever part operates in a direction in which the driver desires to cause the host vehicle M to change lanes, the host vehicle M changes lanes in a direction corresponding to the operation. The lane change instruction may be an operation different from the operation of the lever part of the operation switch of the direction indicator. For example, when a predetermined operation button has been pressed, the lane change may be made.

For example, the lane change controller 160 executes a lane change when the following conditions are satisfied. The conditions are, for example, that there are no obstacles in a lane of a lane change destination, that there is no interference with other vehicles in the vicinity when the lane change is made, that there is no lane change prohibited segment (that there are no road markings or signs prohibiting the lane change), that a lane of a lane change destination is recognized (that it is real), that a yaw rate detected by the vehicle sensor 40 is less than a threshold value, that a radius of curvature of the road during traveling is greater than or equal to a predetermined value, and the like. The conditions for executing the lane change may include other conditions or some conditions may be omitted.

The lane change controller 160, for example, may execute the lane change under the condition that the driver is gripping the steering wheel 82 (or that the steering grip sensor 86 has detected the gripping of the steering wheel 82).

The planner 170 generates a plan for causing the host vehicle M to travel on the basis of a route toward a destination set by an occupant. In principle, the planner 170 generates a target trajectory along which the host vehicle M travels in the recommended lane decided by the recommended lane decider 61 and further the host vehicle M will automatically travel in the future (regardless of the driver's operation) so that it is possible to cope with a surrounding situation of the host vehicle M. The target trajectory may include, for example, a speed element. For example, the target trajectory is represented by sequentially arranging points (trajectory points) at which the host vehicle M is required to arrive. The trajectory points are points at which the host vehicle M is required to arrive for each predetermined traveling distance (e.g., about several meters [m]) along a road. In addition, a target speed and target acceleration for each predetermined sampling time (e.g., about 0.x [sec] where x is a decimal number) are generated as parts of the target trajectory. Also, the trajectory point may be a position where the host vehicle M is required to arrive at the sampling time for each predetermined sampling time. In this case, information of the target speed or the target acceleration is represented by an interval between the trajectory points.

For example, the planner 170 causes the host vehicle M to travel along a target trajectory in cooperation with the curve determiner 130, the speed controller 140, the lane-keeping controller 150, and the lane change controller 160. For example, the planner 170 generates an action plan of the host vehicle M so that the speed controller 140 controls the speed of the host vehicle M, the lane-keeping controller 150 controls steering, and the driver controls the speed, if necessary, grips the steering wheel 82, or operates the steering wheel 82 for arrival at a destination in a state in which the driver of the host vehicle M is monitoring the surroundings of the host vehicle M. For example, the planner 170 generates a plan for causing the host vehicle M to travel in an operation of the driver in a first segment and causing the host vehicle M to travel under control of the driving assistance device 100 in a second segment, and causes the host vehicle M to travel in cooperation with the driver, the curve determiner 130, the speed controller 140, the lane-keeping controller 150, and the lane change controller 160 in accordance with the plan.

The information provider 180 causes the HMI to output various types of information about the state of the host vehicle M and driving assistance by an audio or image.

The travel driving force output device 200 outputs a travel driving force (torque) for enabling the traveling of the host vehicle M to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the speed controller 140 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the speed controller 140 or the information input from the driving operation element 80 so that brake torque according to a braking operation is output to each wheel.

For example, the steering device 220 includes a steering ECU and an electric motor. For example, the electric motor changes a direction of steerable wheels by applying a force to a rack and pinion mechanism. The steering ECU drives the electric motor in accordance with the information input from the lane-keeping controller 150 or the lane change controller 160 or the information input from the driving operation element 80 to change the direction of the steerable wheels.

### Speed Adjustment Control

The driving assistance device 100 executes driving assistance control and controls the speed of the host vehicle M in accordance with the driver's gripping state of the steering wheel 82 during traveling on a curved road. The driving assistance control is control in which the speed controller 140 controls the speed of the host vehicle M and the lane-keeping controller 150 executes lane-keeping control in a state in which the driver is monitoring the surroundings of the host vehicle M. The driving assistance device 100, for example, causes the host vehicle M to travel at a lower speed in a case where the driver is not gripping the steering wheel 82 while the host vehicle M is traveling on a curved road than in a case where the driver is gripping the steering wheel 82 and causes the host vehicle M to accelerate or suppresses the deceleration of the host vehicle M when it is determined that the driver has gripped the steering wheel 82 in a case where the driver is not gripping the steering wheel 82 and causes the host vehicle M to travel on the curved road at a low speed. The time of traveling on a curved road, for example, may be the time of traveling on a road (lane) that is curved as a curved road or may include the time when the host vehicle M has started deceleration to enter the curved road in addition to the above.

For example, the driving assistance device 100 causes the host vehicle M to travel in a first speed plan when the driver is gripping the steering wheel 82 while the host vehicle M is traveling on a curved road and causes the host vehicle M to travel in a second speed plan when the driver is not gripping the steering wheel 82 while the host vehicle M is traveling on a curved road. If the driver is not gripping the steering wheel 82 and causes the host vehicle M to travel in the second speed plan, the driving assistance device 100 switches the plan from the second speed plan to the first speed plan and causes the host vehicle M to travel on the basis of the first speed plan when it is determined that the driver has gripped the steering wheel 82. When the driver has gripped the steering wheel 82 in a case where the speed of the host vehicle M is controlled on the basis of the second speed plan, the driving assistance device 100 decelerates or accelerates the host vehicle M to cause the speed of the host vehicle M to be consistent with the speed specified in the first speed plan. The first speed plan and the second speed plan are information indicating a change in the speed of the host vehicle M at the time of traveling on a curved road and the second speed plan is a plan for causing the host vehicle M to travel at a lower speed than the first speed plan. Hereinafter, details of the speed adjustment control will be described.

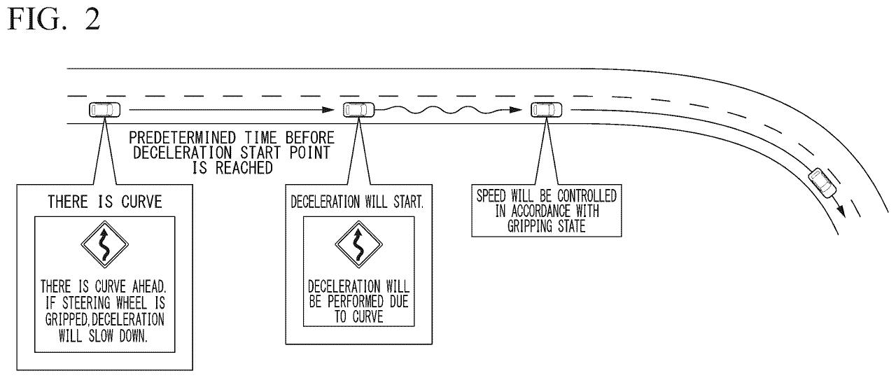

FIG. 2 is an explanatory diagram of speed adjustment control. The driving assistance device 100 provides the driver with first proposal information via the HMI 30 before the curved road is reached. The first proposal information includes, for example, that there is a curved road in front and that the deceleration of the host vehicle M slows down at the time of traveling on the curved road if the steering wheel 82 is gripped. When the host vehicle M reaches a position where deceleration starts, the driving assistance device 100 decelerates the host vehicle M.

The above-described deceleration degree and the speed of the host vehicle M are decided on the basis of the driver's gripping state of the steering wheel 82. For example, when the driver is gripping the steering wheel 82 (in a hands-on case), the driving assistance device 100 decelerates the host vehicle M at a first deceleration degree. For example, when the driver is not gripping the steering wheel 82 (in a hands-off case), the driving assistance device 100 decelerates the host vehicle M at a second deceleration degree. The second deceleration degree is a deceleration degree higher than the first deceleration degree. The host vehicle M is allowed to travel at a higher speed in the hands-on case than in the hands-off case.

In other words, the driving assistance device 100 decides the target speed in accordance with the gripping state of the steering wheel 82. For example, the target speed in the hands-on state is set to be higher than the target speed in the hands-off state.

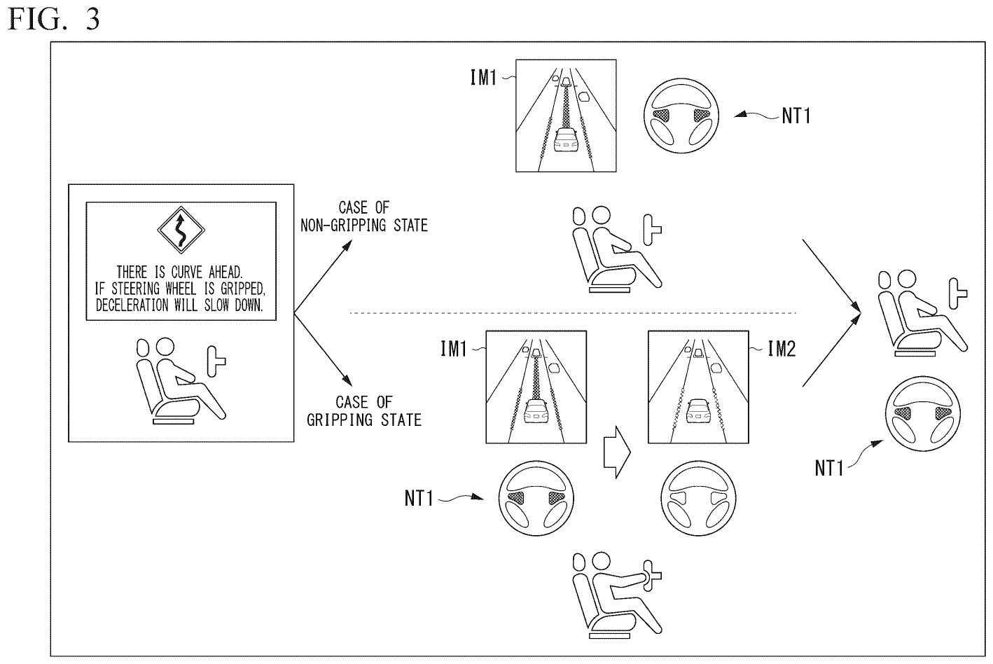

FIG. 3 is an explanatory diagram of a state of the driver and information provided via the HMI 30. For example, when the driver does not grip the steering wheel 82 in accordance with first proposal information, a first image IM1 is displayed and a first notification is output. The first image IM1 is information indicating that hands-off lane-keeping control is being executed. A first notification NT1 is a notification for recommending the hands-on state by emitting light in a first aspect with a light emitter provided on the steering wheel 82.

For example, when the driver has gripped the steering wheel 82 in accordance with the first proposal information, a second image IM2 is displayed instead of the first image IM1 and the output of the first notification NT1 is stopped. The second image IM2 is information indicating that hands-on lane-keeping control is being executed when the steering wheel 82 has been gripped. The driving assistance device 100 provides the driver with second proposal information via the HMI 30 and notifies the driver only about the deceleration for the curve. The second proposal information is information indicating that the host vehicle M decelerates for traveling on a curved road. Subsequently, when the host vehicle M has reached the end of the curved road or near the end, the driving assistance control (hands-off lane-keeping control) is continued or resumed.

### Relationship Between Operation and Control at Time of Traveling on Curved Road

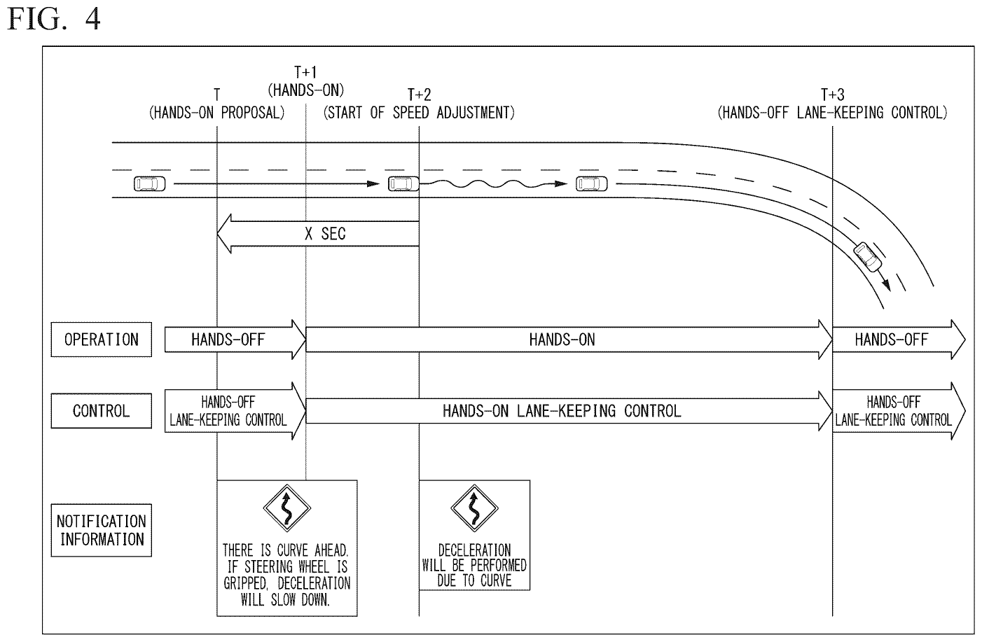

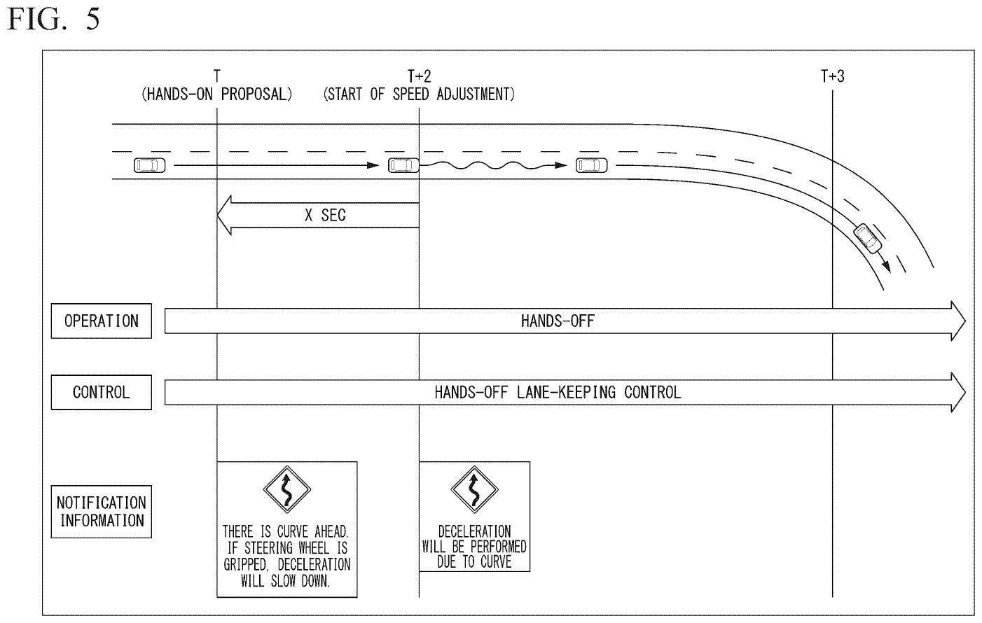

Control in the hands-on case (FIG. 4) and control in the hands-off case (FIG. 5) at the time of traveling on a curved road will be described with reference to FIGS. 4 and 5.

FIG. 4 is an explanatory diagram (Part 1) of speed adjustment control. Time T is a timepoint at which the driving assistance device 100 has made a hands-on proposal (a timepoint at which the first proposal information is provided). Time T is, for example, a timepoint that is earlier than time T+2 to be described below by a predetermined number of seconds (e.g., 5 sec, 6 sec, 7 sec, or the like). Time T may be a timepoint before a predetermined distance from time T+2.

When the driver has performed a hands-on operation at time T+1, the second proposal information is provided to the driver and the driving assistance device 100 executes the hands-on lane-keeping control instead of the hands-off lane-keeping control. At time T+2, the driving assistance device 100 starts the adjustment of the speed of the host vehicle M to cause the host vehicle M to travel on the curved road. Time T+2 is, for example, a timepoint when deceleration starts. Time T+2 is a timing when the host vehicle M has reached the entrance of the curved road or within a predetermined distance before the entrance, or the like. The entrance to the curve is, for example, a position where the road (lane) begins to curve or a position where the road has curvature greater than or equal to a threshold value. Time T+2 is a timepoint corresponding to a position decided on the basis of a shape (curvature) of the curved road, a speed of the host vehicle M, a surrounding situation, and the like.

From time T+2 to time T+3, the driving assistance device 100 controls the speed on the basis of the first speed plan. The first speed plan is a future speed change adopted when the steering wheel 82 is gripped. The first speed plan is, for example, a plan in which a maximum load on the occupant in the case of traveling on the curved road is less than a first degree. The load is, for example, acceleration. The load may be lateral acceleration for the occupant. The first degree is, for example, about 0.2 G to 0.3 G (e.g., 0.25 G).

At time T+3, the driving assistance device 100 executes the hands-off lane-keeping control instead of the hands-on lane-keeping control. Time T+3 is a timepoint when the host vehicle M has arrived at or near the exit of the curved road. The exit of the curve is, for example, a position where the road (lane) is straightened, a position where the curvature of the road is less than a threshold value, a position set in advance in the map information, and the like. After time T+3, the hands-off lane-keeping control is executed regardless of the hands-on or hands-off.

FIG. 5 is an explanatory diagram (Part 2) of speed adjustment control. The differences from the description of FIG. 4 will be mainly described. When the hands-on operation has not been performed after time T, the driving assistance device 100 continuously executes the hands-off lane-keeping control. From time T+2 to time T+3, the driving assistance device 100 controls the speed on the basis of the second speed plan. The second speed plan is a future speed change adopted when the steering wheel 82 is not gripped. The speed of the second speed plan is a plan of a change in a speed lower than the speed of the first speed plan. The second speed plan, for example, is a plan in which the maximum load on the occupant in the case of traveling on the curved road is less than a second degree. The second degree is, for example, about 0.1 G to 0.2 G (e.g., 0.15 G). As shown in FIG. 5, when the hands-off lane-keeping control is continued, the information of a notification provided at time T is continuously displayed even after time T+2.

### Flowchart (Part 1)

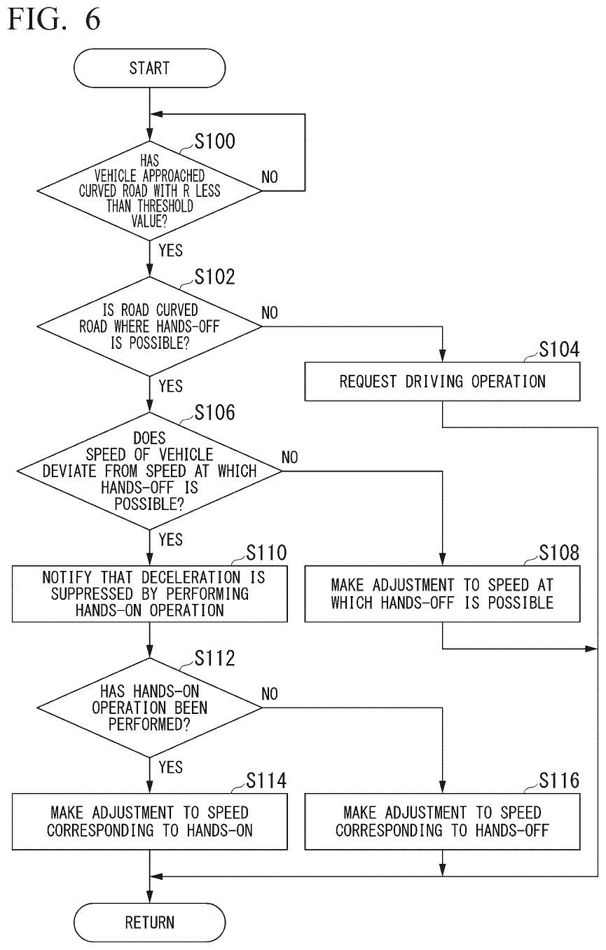

FIG. 6 is a flowchart (Part 1) showing an example of a flow of a process executed by the driving assistance device 100. First, the curve determiner 130 determines whether or not the host vehicle M has approached a curved road with R (a circular radius) of the curve less than the threshold value on the basis of the position of the host vehicle M and the map information (step S100). The approach indicates that the host vehicle M is located within a predetermined distance or that the host vehicle M reaches a curved road after a predetermined number of seconds. R is less than the threshold value, for example, R is about 200 to 400. R is less than the threshold value, for example, R is 300.

When the host vehicle M has approached the curved road with R of the curve less than the threshold value, the curve determiner 130 determines whether or not the approaching curved road is a curved road where the hands-off is possible (step S102). When the approaching curved road is not a curved road where the hands-off is possible, the driving assistance device 100 requests the driver to perform a driving operation via the HMI 30 (S104). When a notification of this request has been provided, the host vehicle M travels on a curved road according to the driver's operation.

Information indicating whether or not the curved road is a curved road where the hands-off is possible may be stored in the map information or the driving assistance device 100 may be determined on the basis of a recognition result of the physical object recognition device 16. The curved road where the hands-off is not possible is a curved road where it is difficult to identify the position of the host vehicle M, it is difficult to recognize a road, lane, and surrounding situation on the basis of an image captured by the camera 10, or it is difficult to identify a course along which the host vehicle M travels. When R of the curved road is less than the threshold value (when the curved road is a sharp curve), it may be determined that the curved road is not a curved road where the hands-off is possible.

When the approaching curved road is a curved road where the hands-off is possible, the driving assistance device 100 determines whether or not the speed of the host vehicle M deviates from a speed at which the host vehicle M travels on the curved road in the hands-off state by a predetermined speed or more (S106). When there is no deviation of the predetermined speed or more, the driving assistance device 100 adjusts the speed of the host vehicle M to a speed of traveling on a curved road in the hands-off state on the basis of a timing when the speed adjustment starts (S108). When there is no deviation of the predetermined speed or more as described above, the speed is close to the speed at which the host vehicle M is already traveling on the curved road in the hands-off state (or close to the speed of the second speed plan). Even if the host vehicle M travels in the second speed plan of the hands-off, because there is no deviation from the sense of the occupant, the speed of the host vehicle M is controlled as described above. For example, if a traffic jam occurs or the speed of the preceding vehicle is slow, the speed of the host vehicle M may be close to the speed of the second speed plan. In this case, even if control is executed on the basis of the second speed plan, the occupant does not feel uncomfortable or the control is consistent with the occupant's sense.

When there is a deviation of a predetermined speed or more, the driving assistance device 100 notifies the driver of the first proposal information indicating that deceleration is suppressed by performing the hands-on operation (S110). Subsequently, the driving assistance device 100 determines whether or not the hands-on operation has been performed (S112). When the hands-on operation has been performed, the driving assistance device 100 adjusts the speed of the host vehicle M to a speed corresponding to the hands-on operation (S114). The driving assistance device 100 controls, for example, the speed of the host vehicle M on the basis of the first speed plan. When the hands-on operation has not been performed, the driving assistance device 100 adjusts the speed of the host vehicle M to the speed corresponding to the hands-off operation (S116). The driving assistance device 100, for example, controls the speed of the host vehicle M on the basis of the second speed plan.

As described above, the driving assistance device 100 can control the speed of the host vehicle M so that the speed becomes a speed consistent with the occupant's sense in accordance with the driver's gripping state of the steering wheel 82.

When the host vehicle M travels on a curved road (a loose curved road) where R of the curve is greater than or equal to the threshold value, the driving assistance device 100 may control the host vehicle M at a speed consistent with the driver's sense (without excessive deceleration) to execute hands-off lane-keeping control. In this case, regardless of the hands-on or hands-off, the speed of the host vehicle M may be controlled by the same speed plan.

### Flowchart (Part 2)

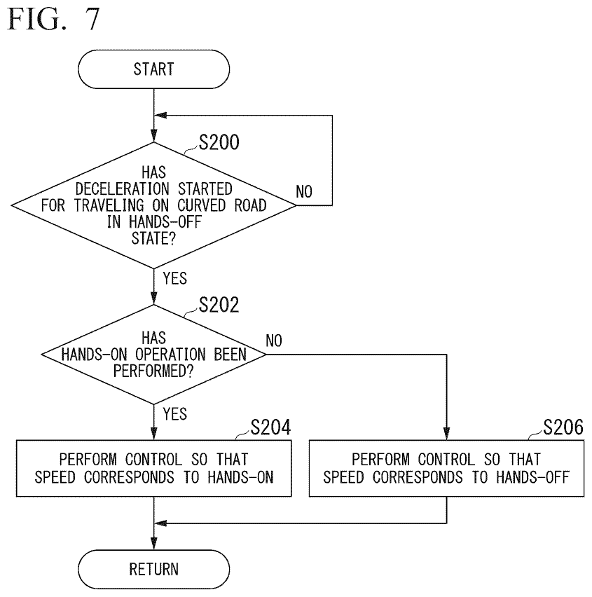

FIG. 7 is a flowchart (Part 2) showing an example of a flow of a process executed by the driving assistance device 100. This process is a process related to control of the speed when the hands-on operation is performed when the speed is adjusted on the basis of the second speed plan of the hands-off operation.

First, when the adjustment of the speed for traveling on a curved road in the hands-off state has started (step S200), the driving assistance device 100 determines whether or not the hands-on operation has been performed (S202). When the hands-on operation has been performed during a predetermined period, the driving assistance device 100 controls the speed of the host vehicle M so that the speed becomes a speed corresponding to the hands-on (a speed based on the first speed plan) (step S204). When the hands-on operation has not been performed, the driving assistance device 100 controls the speed of the host vehicle M so that the speed becomes a speed corresponding to the hands-off (a speed based on the second speed plan) (step S206). Thereby, the process of one routine of the present flowchart ends.

Although an example in which the driving assistance device 100 controls the speed according to the driver's gripping state of the steering wheel 82 has been described in the above-described example (as in an example to be described below), an automated driving control device (not shown) may execute a similar process in addition to this (alternatively). The automated driving control device controls the speed and steering of the host vehicle M without depending on the driver's operation. The automated driving control device controls the speed in accordance with the driver's gripping state of the steering wheel 82 at the time of traveling on a curved road. For example, the automated driving control device causes the host vehicle M to travel at the first deceleration when the driver has gripped the steering wheel 82 or causes the host vehicle M to travel at the second deceleration (a speed less than the first deceleration) when the driver has not gripped the steering wheel 82. Thereby, the automated driving control device can implement automated driving consistent with the occupant' sense in automated driving and improve the comfort of the occupant. The automated driving control device is an example of a “control device.”

### Control at Time of Traveling on First and Second Curved Roads

The driving assistance device 100 causes the host vehicle M to travel in the first speed plan when the driver is gripping the steering wheel 82 on the first curved road C1 and causes the host vehicle M to travel in the second speed plan for causing the host vehicle M to travel at a lower speed than the first speed plan when the driver is not gripping the steering wheel 82 on the first curved road C1.

The driver recognizer 120 determines whether or not the driver of the host vehicle M has gripped the steering wheel 82 during traveling on the first curved road C1. The driver recognizer 120 determines the gripping of the steering wheel 82 on the basis of a detection result of the steering grip sensor 86 on the steering wheel 82. In the case of a gripping state in which the driver has gripped the steering wheel 82, the information provider 180 causes the HMI 30 (the output device) to output the first information in an object segment between the first curved road C1 and the second curved road C2 that is the next curved road after the first curved road C1 where the host vehicle M is scheduled to travel. In the case of a non-gripping state in which the driver is not gripping the steering wheel 82, the information provider 180 causes the HMI 30 (the output device) to output the second information different from the first information in the object segment. The information provider 180 or a functional configuration in which the information provider 180 and the speed controller 140 are combined is an example of a “controller.”

The object segment is a preset segment, a straight segment, or a segment where the curvature of the road (or lane) is less than or equal to a threshold value. The driving assistance device 100 may identify the object segment with reference to the map information or may identify the object segment on the basis of a recognition result of the recognizer 110.

The first information is, for example, information different from information for proposing that the driver should grip the steering wheel 82. The first information is, for example, information indicating that the speed of the host vehicle M is suppressed so that the host vehicle M travels on the first curved road C1. The second information is, for example, information for proposing that the driver should grip the steering wheel 82. The second information is, for example, information indicating that the host vehicle M travels at a higher speed when the driver is gripping the steering wheel 82 than when the driver is not gripping the steering wheel 82 on the first curved road C1.

In the above-described aspects, the length in the object segment may be further considered. The curve determiner 130 acquires the length of the object segment. The driver recognizer 120, the curve determiner, or a functional configuration in which the driver recognizer and the curve determiner 130 are combined is an example of a “processor.”

The information provider 180 differentiates the information to be output by the HMI 30 (the output device) while the host vehicle M is traveling in the object segment on the basis of the distance of the object segment. When the object segment corresponds to a distance less than or equal to a first distance or corresponds to a distance less than or equal to a third distance longer than a second distance longer than the first distance, the information provider 180 causes the HMI 30 to output the same information in the object segment regardless of whether the steering wheel 82 is in the gripping state or the non-gripping state. If the object segment corresponds to a distance less than or equal to the second distance, the information provider 180 causes the HMI 30 to output third information when the steering wheel 82 is in the gripping state and causes the HMI 30 to output fourth information different from the third information when the steering wheel 82 is in the non-gripping state.

The third information is different from information for proposing that the driver should grip the steering wheel 82. The fourth information is information for proposing that the driver should grip the steering wheel 82.

### Process of Case Where Object Segment is Within First Distance

### (Scene 1A)

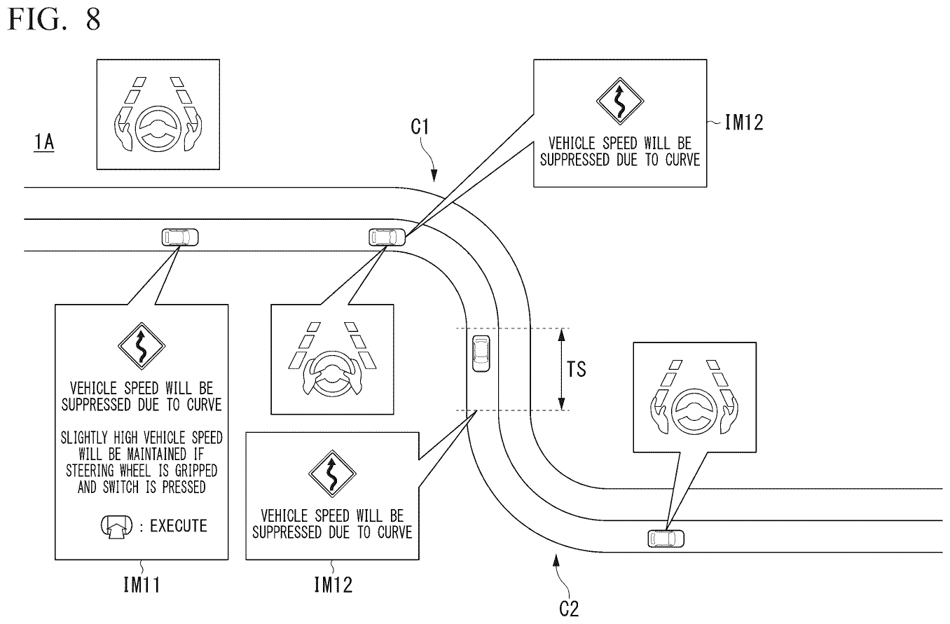

FIG. 8 is an explanatory diagram of a process in scene 1A. It is assumed that the host vehicle M travels on a first curved road C1, an object segment TS, and a second curved road C2 in that order. For example, it is assumed that ACC is set before entry into the first curved road C1. It is assumed that the driver is not gripping the steering wheel 82 before the host vehicle M enters the first curved road C1. Before the host vehicle M enters the first curved road C1, the driving assistance device 100 provides the driver with an image IM11 using the HMI 30. The image IM11 is an image including information indicating that the speed of the host vehicle M is suppressed on a curved road and information (proposal information) indicating that the host vehicle M travels on the first curved road C1 at a higher speed when the steering wheel 82 is gripped than when the steering wheel 82 is not gripped.

It is assumed that the driver has gripped the steering wheel 82 just before the first curved road C1. At this time, the driving assistance device 100 provides the driver with an image IM12 using the HMI 30. The image IM12 is an image including information indicating that the speed of the host vehicle M is suppressed on a curved road.

After the host vehicle M passes through the first curved road C1, when the host vehicle M has entered the object segment (or before the host vehicle M enters the object segment), the driving assistance device 100 provides the driver with the image IM12 using the HMI 30. The object segment corresponds to a distance less than or equal to the first distance. The first distance is, for example, 100 m, 150 m, several hundred meters, or the like. The first distance and the second distance and the third distance to be described below may be variable with the speed of the host vehicle M.

After the host vehicle M passes through the second curved road C2, the driving assistance device 100 controls the host vehicle M so that the host vehicle M travels at a preset speed even if the driver releases his or her hand from the steering wheel 82.

For example, when the driver releases his or her hand from the steering wheel 82 in the object segment, (1) the host vehicle M may be controlled at the target speed in the non-gripping state on the second curved road C2 and (2) the host vehicle M may be controlled so that the target speed is maintained in the gripping state on the second curved road C2. In these cases, after the host vehicle M passes through the first curved road C1, the driving assistance device 100 does not increase the speed of the host vehicle M to a set speed set in the ACC and controls the host vehicle M so that the speed of the host vehicle M is close to the target speed set with respect to the second curved road C2 (the target speed of the gripping state or the target speed of the non-gripping state) in the object segment. The same is true for scene 2A to be described below.

For example, in the case of the above-described (2), the driving assistance device 100 may notify the driver of an image, a sound, or the like for requesting the driver to grip the steering wheel. When the steering wheel is not gripped even through this notification, the driving assistance device 100 may end the driving assistance and switch control to manual driving. The same is also true for scene 2A to be described below.

### (Scene 1B)

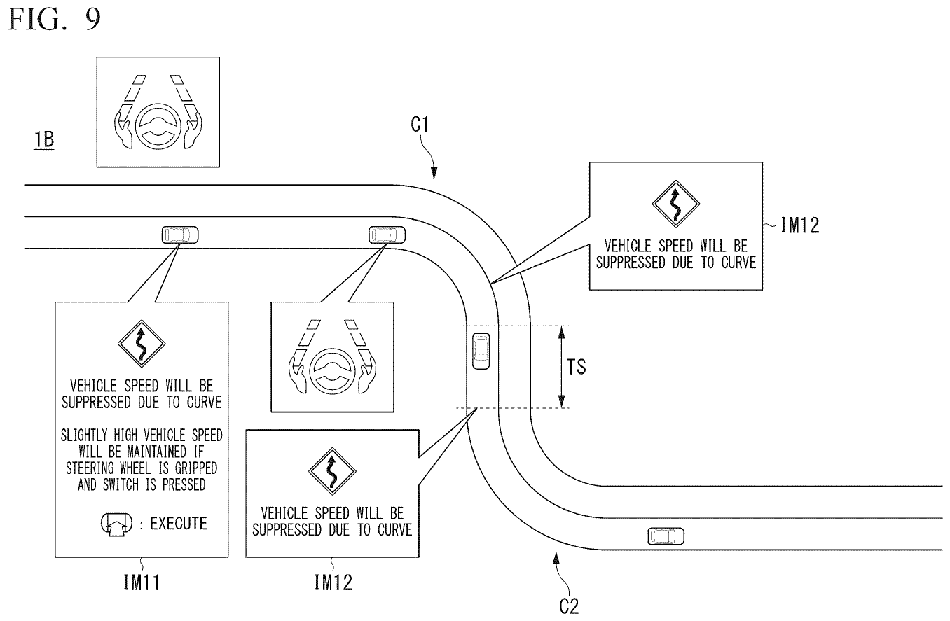

FIG. 9 is an explanatory diagram of a process in scene 1B. The differences from FIG. 8 will be mainly described. It is assumed that the driver is not gripping the steering wheel 82 just before the first curved road C1. At this time, the driving assistance device 100 provides the driver with the image IM12 using the HMI 30.

After the host vehicle M passes through the first curved road C1, when the host vehicle M has entered the object segment (or before the host vehicle M enters the object segment), the driving assistance device 100 provides the driver with the image IM12 using the HMI 30.

For example, when the driver has gripped the steering wheel 82 in the object segment or on the second curved road C2, (3) the host vehicle M may be controlled at the target speed in the gripping state on the second curved road C2 and (4) the host vehicle M may be controlled so that the target speed is maintained in the non-gripping state on the second curved road C2. In these cases, after the host vehicle M passes through the first curved road C1, the driving assistance device 100 does not increase the speed of the host vehicle M to a set speed set in the ACC and controls the host vehicle M so that the speed of the host vehicle M is close to the target speed set with respect to the second curved road C2 (the target speed of the gripping state or the target speed of the non-gripping state) in the object segment.

In the above-described scenes 1A and 1B, because the driving assistance device 100 does not propose that the host vehicle M should travel on the second curved road C2 in the first speed plan in the object segment, the hassle of notifying the driver can be suppressed.

### Process of Case Where Object Segment is Within Second Distance

If the object segment is within the second distance, when the state is the gripping state in which the driver is gripping the steering wheel 82, the driving assistance device 100 causes the HMI 30 to output information output by the HMI 30 during traveling on the first curved road C1 or causes the HMI 30 to output information of a type that is the same as that of the output information even in the object segment (see scene 2A). The same type of information is information indicating that the speed of the host vehicle M is suppressed to travel on the curved road. Specifically, the information is the image IM12.

If the object segment is within the second distance, when the state is the non-gripping state in which the driver is not gripping the steering wheel 82, the driving assistance device 100 causes the HMI 30 to output information of a type different from that of the information output by the HMI 30 during traveling on the first curved road C1 even in the object segment (see scene 2B). The different type of information is, for example, information indicating that the driving assistance device 100 causes the host vehicle M to travel at a higher speed when the driver is gripping the steering wheel 82 than when the driver is not gripping the steering wheel 82 at the time of traveling on the second curved road C2. Specifically, the information is the image IM11.

### (Scene 2A)

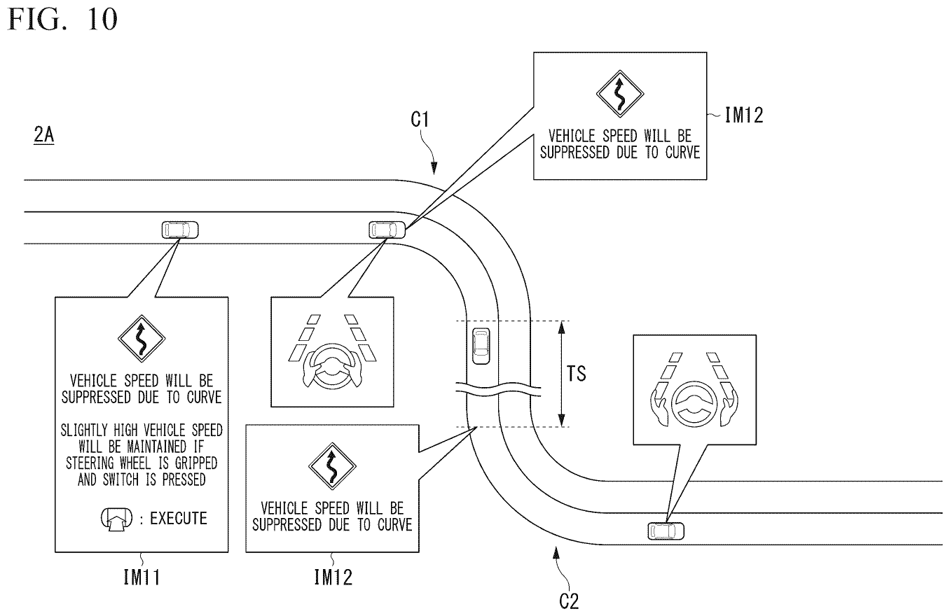

FIG. 10 is an explanatory diagram of a process in scene 2A. The differences from FIG. 8 will be mainly described. It is assumed that the driver is gripping the steering wheel 82 just before the first curved road C1. At this time, the driving assistance device 100 provides the driver with the image IM12 using the HMI 30.

After the host vehicle M passes through the first curved road C1, when the host vehicle M has entered the object segment (or before the host vehicle M enters the object segment), the driving assistance device 100 provides the driver with the image IM12 using the HMI 30. The object segment is the second distance, which is longer than the first distance. The second distance is, for example, several hundred meters longer than the first distance. The second distance is, for example, a predetermined distance of 100 m or more and less than 300 m or the like.

After the host vehicle M passes through the second curved road C2, the driving assistance device 100 controls the host vehicle M so that the host vehicle M travels at a preset speed even if the driver releases his or her hand from the steering wheel 82.

### (Scene 2B)

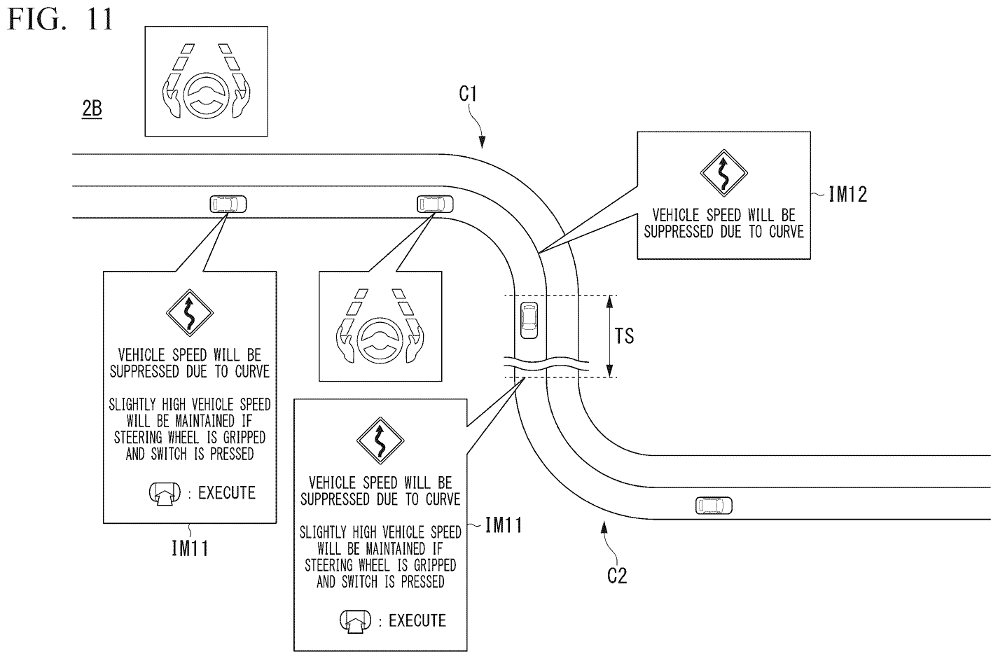

FIG. 11 is an explanatory diagram of a process in scene 2B. The differences from FIG. 10 will be mainly described. It is assumed that the driver is not gripping the steering wheel 82 just before the first curved road C1. At this time, the driving assistance device 100 provides the driver with the image IM12 using the HMI 30.

After the host vehicle M passes through the first curved road C1, when the host vehicle M has entered the object segment (or before the host vehicle M enters the first curved road C1), the driving assistance device 100 provides the driver with the image IM11 using the HMI 30. For example, in the object segment, the driving assistance device 100 controls the host vehicle M so that the speed of the host vehicle M approaches the set speed (e.g., the set speed of ACC) set for the object segment. In scene 2B, in the object segment, as shown in the image IM12, information indicating that the speed of the host vehicle M is suppressed on the second curved road C2 may not be provided to the driver.

For example, when the driver has gripped the steering wheel 82 in the object segment or on the second curved road C2, the driving assistance device 100 controls the host vehicle M at the target speed (the target speed of the first speed plan) in the gripping state on the second curved road C2.

As described above, the driving assistance device 100 can cause the host vehicle M to travel on a compound curve by respecting the driver's determination result on the first curved road C1. Further, in scene 2B, because the driving assistance device 100 again asks the driver about the intention regarding the speed plan, the host vehicle M travels in an aspect that is more suitable for the driver's preference on the second curved road C2. In the above-described scenes 2B, because the driving assistance device 100 makes a proposal for causing the host vehicle M to travel on the second curved road C2 in the first speed plan in the object segment, convenience for the driver can be improved.

### Process of Case Where Object Segment is Within Third Distance

### (Scene 3A)

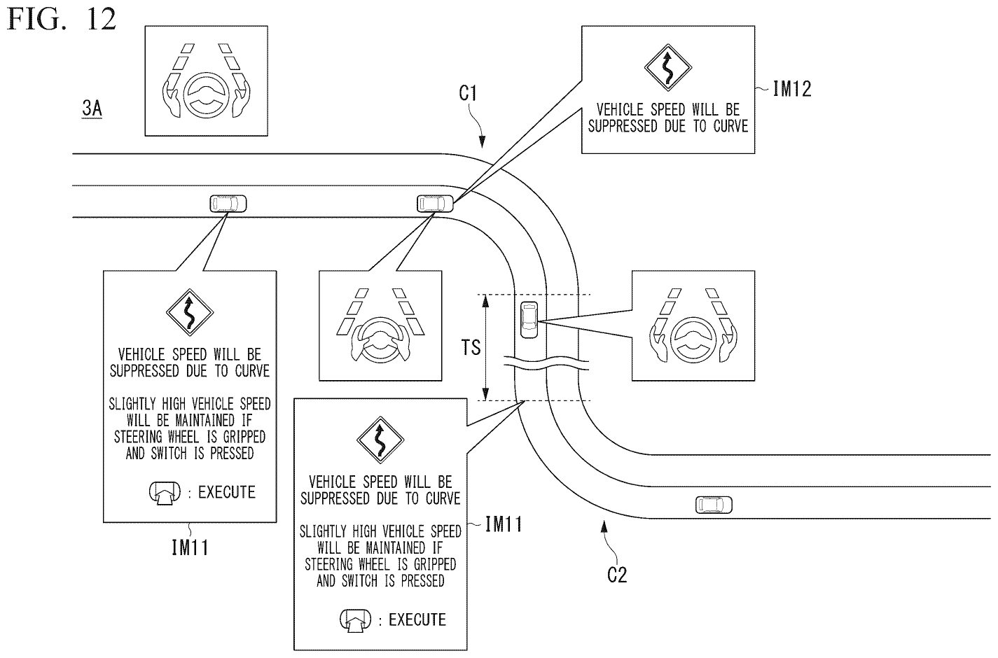

FIG. 12 is an explanatory diagram of a process in scene 3A. The differences from FIG. 10 will be mainly described. It is assumed that the driver has gripped the steering wheel 82 just before the first curved road C1. At this time, the driving assistance device 100 provides the driver with the image IM12 using the HMI 30.

After the host vehicle M passes through the first curved road C1, when the host vehicle M has entered the object segment (or before the host vehicle M enters the object segment), the driving assistance device 100 provides the driver with an image IM11 using the HMI 30. The object segment corresponds to the third distance, which is longer than the first and second distances. The third distance is, for example, several hundred meters longer than the second distance. The third distance is a predetermined distance of, for example, 300 m or more or the like.

For example, when the driver has released his or her hand from the steering wheel 82 in the object segment, the driving assistance device 100 controls the speed of the host vehicle M in the object segment so that the speed of the host vehicle M approaches the set speed (e.g., the set speed of ACC) set for the object segment. In scene 3A, in the object segment, as shown in the image IM12, information indicating that the speed of the host vehicle M is suppressed on the second curved road C2 may not be provided to the driver.

### (Scene 3B)

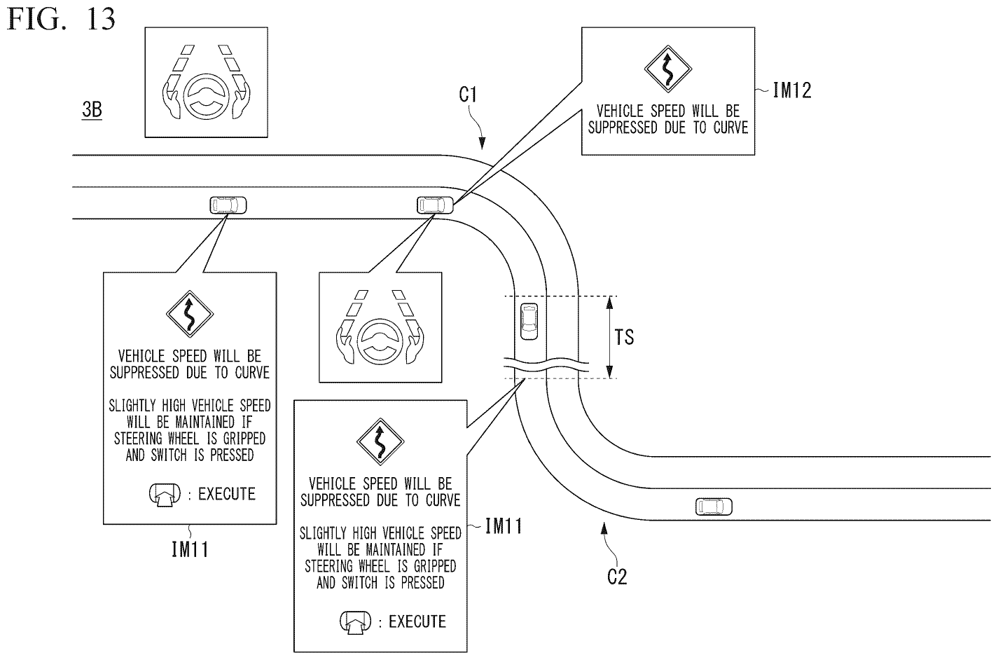

FIG. 13 is an explanatory diagram of a process in scene 3B. The differences from FIG. 12 will be mainly described. It is assumed that the driver has not gripped the steering wheel 82 just before the first curved road C1. After the host vehicle M passes through the first curved road C1, when the host vehicle M has entered the object segment (or before the host vehicle M enters the object segment), the driving assistance device 100 provides the driver with the image IM11 using the HMI 30. The other processing is similar to that in scene 3A.

In the above-described scenes 3A and 3B, because the driving assistance device 100 makes a proposal for causing the host vehicle M to travel on the second curved road C2 in the first speed plan in the object segment, convenience for the driver can be improved.

As described above, the information to be provided to the driver may be decided by dividing a range of the object segment into three types or the information to be provided to the driver may be decided by dividing the range of the object segment into two or four or more types.

For example, the driving assistance device 100 causes the host vehicle M to travel in the first speed plan when the driver is gripping the steering wheel 82 on the first curved road C1 and causes the host vehicle M to travel in the second speed plan for causing the host vehicle M to travel at a lower speed than the first speed plan when the driver is not gripping the steering wheel 82 on the first curved road C1. The driving assistance device 100 prevents any proposal that the host vehicle M should travel in the third speed plan for causing the host vehicle M to travel on the second curved road at a higher speed than the fourth speed plan if the steering wheel 82 is gripped when the driver has not gripped the steering wheel 82 on the first curved road C1 in a case where the object segment is a first range of a preset distance, and proposes that the host vehicle M should travel on the second curved road in the third speed plan if the steering wheel 82 is gripped when the driver has not gripped the steering wheel 82 on the first curved road C1 in a case where the object segment is a preset distance range as a second range larger than the first range.

The driving assistance device 100 causes the host vehicle M to travel on the second curved road in the third speed plan when the driver has gripped the steering wheel 82 in accordance with the above-described proposal and causes the host vehicle M to travel on the second curved road in the fourth speed plan when the driver has not gripped the steering wheel 82 without accepting the above-described proposal.

The distance of the first range is, for example, the first distance. The distance of the second range is, for example, the second distance or the third distance. The distance of the first range is, for example, the second distance, and the distance of the second range may be, for example, the third distance.

The content of the present embodiment can also be expressed as follows. The curve determiner 130 acquires a distance of the object segment between the first curved road C1 and the second curved road, which is the next curved road after the first curved road C1. When the distance of the object segment between the first curved road C1 and the second curved road is less than a predetermined distance, the information provider 180 prevents any proposal that the host vehicle M should travel on the second curved road in the third speed plan at a higher speed than the fourth speed plan if the driver grips the steering wheel 82 in a non-gripping state in which the driver of the host vehicle M is not gripping the steering wheel 82 while the host vehicle M is traveling on the first curved road C1.

When the distance of the object segment is greater than or equal to the predetermined distance, the information provider 180 proposes that the host vehicle M should travel on the second curved road in the third speed plan at a higher speed than the fourth speed plan if the steering wheel 82 is gripped in a non-gripping state in which the driver is not gripping the steering wheel 82 while the host vehicle M is traveling on the first curved road C1.

A distance less than a predetermined distance is, for example, the first distance, and a distance greater than or equal to the predetermined distance is, for example, the second distance or the third distance. A distance less than the predetermined distance is, for example, the second distance, and the distance greater than or equal to the predetermined distance may be, for example, the third distance.

### Flowchart

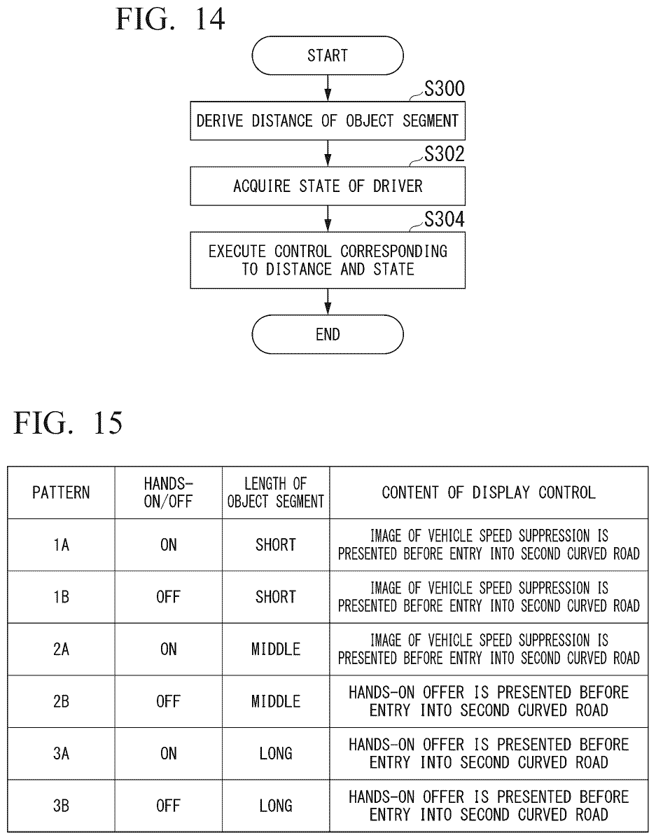

FIG. 14 is a flowchart showing an example of a flow of a process executed by the driving assistance device 100. This process is a process executed before or immediately after the host vehicle M enters the object segment.

First, the driving assistance device 100 derives a distance of the object segment between the first curved road C1 and the second curved road C2 (step S300). The driving assistance device 100 acquires the state of the driver on the first curved road C1 (step S302). The driver's state is a state in which the driver has gripped or not gripped the steering wheel 82 on the first curved road C1. Subsequently, the driving assistance device 100 executes control corresponding to the distance and state of the object segment (step S304). For example, the driving assistance device 100 provides information to the driver in the object segment in accordance with the distance and state of the object segment in the above-described scenes 1A to 3B and performs a process corresponding to the driver's gripping state of the steering wheel 82. Thereby, the process of one routine of the present flowchart ends.

FIG. 15 is an explanatory diagram of each scene. In scene 1A, the driving assistance device 100 presents an image indicating that “the vehicle speed is suppressed due to the curved road” before entry into the second curved road C2 to the driver. The same is also true for scenes 1B and 2A.

In scene 2B, the driving assistance device 100 presents a “hands-on offer” image to the driver before entry into the second curved road C2. The hands-on offer image is an image indicating that the host vehicle M travels on a curved road at a higher speed when the driver is gripping the steering wheel 82 than when the driver is not gripping the steering wheel 82. The same is also true for scenes 3A and 3B.

According to the embodiment described above, the driving assistance device 100 causes the HMI 30 to output the first information in an object segment between the first curved road C1 and the second curved road C2 that is the next curved road after the first curved road C1 where the host vehicle M is scheduled to travel in the case of a gripping state in which the driver has gripped the steering wheel 82 and causes the HMI 30 to output the second information different from the first information in the object segment in the case of the non-gripping state in which the driver is not gripping the steering wheel 82, thereby providing useful information for the occupant (e.g., the driver) of the vehicle.

The embodiment described above can be represented as follows.

A control device including:
a storage device storing a program; and
a hardware processor, the hardware processor executing the program to:
   determine whether or not a driver of a vehicle is gripping a steering wheel while the vehicle is traveling on a curved road,
   cause an output device to output first information in an object segment between the first curved road and a second curved road that is the next curved road after the first curved road on which the vehicle is scheduled to travel in a gripping state in which the driver is gripping the steering wheel, and
   cause the output device to output second information different from the first information in the object segment in a non-gripping state in which the driver is not gripping the steering wheel.

Although modes for carrying out the present invention have been described above using embodiments, the present invention is not limited to the embodiments and various modifications and substitutions can also be made without departing from the scope and spirit of the present invention.

What is claimed is:

1. A control device comprising:
a storage medium storing computer-readable instructions; and
one or more processors connected to the storage medium, the processor executing the computer-readable instructions to:
determine whether or not a driver of a vehicle is gripping a steering wheel while the vehicle is traveling on a first curved road,
cause an output device to output first information in an object segment between the first curved road and a second curved road that is the next curved road after the first curved road on which the vehicle is scheduled to travel in a gripping state in which the driver is gripping the steering wheel, and
cause the output device to output second information different from the first information in the object segment in a non-gripping state in which the driver is not gripping the steering wheel.

2. The control device according to claim 1, wherein the processor executes the computer-readable instructions to:
acquire a distance of the object segment, and
differentiate information to be output by the output device while the vehicle is traveling in the object segment on the basis of the distance of the object segment.

3. The control device according to claim 2, wherein the processor executes the computer-readable instructions to:
cause the output device to output the same information in the object segment even if the state is the gripping state or the non-gripping state when the object segment corresponds to a distance less than or equal to a first distance or when the object segment corresponds to a distance less than or equal to a third distance longer than a second distance longer than the first distance, and
cause the output device to output third information in the gripping state when the object segment corresponds to a distance less than or equal to the second distance and cause the output device to output fourth information different from the third information in the non-gripping state.

4. The control device according to claim 3, wherein the processor executes the computer-readable instructions to cause the output device to output information output by the output device during traveling on the first curved road or information having the same type as the output information in the object segment in the gripping state when the object segment corresponds to a distance less than or equal to the second distance.

5. The control device according to claim 3, wherein the third information is information different from information for proposing that the driver should grasp the steering wheel.

6. The control device according to claim 3, wherein the processor executes the computer-readable instructions to cause the output device to output information of a type different from that of the information output by the output device during traveling on the first curved road in the object segment in the non-gripping state when the object segment corresponds to a distance less than or equal to the second distance.

7. The control device according to claim 3, wherein the fourth information is information for proposing that the driver should grasp the steering wheel.

8. The control device according to claim 1, wherein the processor executes the computer-readable instructions to:
cause the vehicle to travel in a first speed plan when the driver is gripping the steering wheel on the first curved road, and
cause the vehicle to travel in a second speed plan for causing the vehicle to travel at a lower speed than the first speed plan when the driver is not gripping the steering wheel on the first curved road.

9. The control device according to claim 1, wherein the processor executes the computer-readable instructions to:
cause the vehicle to travel in a first speed plan when the driver is gripping the steering wheel on the first curved road,
cause the vehicle to travel in a second speed plan at a lower speed than the first speed plan when the driver is not gripping the steering wheel on the first curved road,
prevent any proposal that the vehicle should travel in a third speed plan for causing the vehicle to travel on the second curved road at a higher speed than a fourth speed plan if the steering wheel is gripped when the driver has not gripped the steering wheel on the first curved road in a case where the object segment is a first range of a preset distance, and
propose that the vehicle should travel on the second curved road in a third speed plan if the steering wheel is gripped when the driver has not gripped the steering wheel on the first curved road in a case where the object segment is a preset distance range as a second range larger than the first range.

10. The control device according to claim 9, wherein the processor executes the computer-readable instructions to:
cause the vehicle to travel on the second curved road in the third speed plan when the driver has gripped the steering wheel in accordance with the proposal, and
cause the vehicle to travel on the second curved road in the fourth speed plan when the driver has not gripped the steering wheel without accepting the proposal.

11. A control device comprising:
a storage medium storing computer-readable instructions; and
one or more processors connected to the storage medium, the processor executing the computer-readable instructions to:
acquire a distance of an object segment between a first curved road and a second curved road that is the next curved road after the first curved road,
prevent any proposal that a vehicle should travel on the second curved road in a third speed plan at a higher speed than a fourth speed plan if the steering wheel is gripped in a non-gripping state in which the driver of the vehicle is not gripping the steering wheel while the vehicle is traveling on the first curved road when the distance of the object segment between the first curved road and the second curved road is less than a predetermined distance, and
propose that the vehicle should travel on the second curved road in the third speed plan at a higher speed than the fourth speed plan if the steering wheel is gripped in the non-gripping state in which the driver is not gripping the steering wheel while the vehicle is traveling on the first curved road when the distance of the object segment is greater than or equal to the predetermined distance.

12. A control method comprising steps of:
determining, by a computer, whether a driver of a vehicle is gripping a steering wheel while the vehicle is traveling on a first curved road;
causing, by the computer, an output device to output first information in an object segment between the first curved road and a second curved road that is the next curved road after the first curved road on which the vehicle is scheduled to travel in a gripping state in which the driver is gripping the steering wheel, and
causing, by the computer, the output device to output second information different from the first information in the object segment in a non-gripping state in which the driver is not gripping the steering wheel.
